(19) United States
(12) Patent Application Publication
(10) Pub. No.: US 2007/0234574 A1
(43) Pub. Date: Oct. 11, 2007

(54) Ball bearing assisted cutting implements

(76) Inventors: Richard Constantine, Milford, CT (US); Michael E. Peterson, Fairfield, CT (US); Javier Verdura, Milford, CT (US)

Correspondence Address: WHYTE HIRSCHBOECK DUDEK S.C., 555 East Wells Street, SUITE 1900, MILWAUKEE, WI, 53202-3819, US

(21) Appl. No.: 11/784,170

(22) Filed: Apr. 5, 2007

Related U.S. Application Data
(60) Provisional application No. 60/744,299, filed on Apr. 5, 2006.
(60) Provisional application No. 60/870,787, filed on Dec. 19, 2006.

(51) Int. Cl. B26B 13/00

(52) U.S. Cl. 30/254

(57) ABSTRACT

A hand held instrument is provided with a pair of assemblies, a ball bearing mechanism and mechanism housing. The assemblies are pivotally connected and are mechanically assisted by a plurality of ball bearings. The ball bearing assisted instrument prevents debris and foreign material from interfering with the pivoting action. By providing a housing that encompasses the ball bearing mechanism unwanted debris is hindered from entering the mechanism.

### CROSS REFERENCE TO RELATED APPLICATIONS

This application claims priority to U.S. Patent Application No. 60/744,299, titled “Ball Bearing Assisted Cutting Implements”, filed on Apr. 5, 2006 and herein incorporated by reference in its entirety, and to U.S. Patent Application No. 60/870,787, titled “Cutting Instrument”, filed Dec. 20, 2006, and incorporated by reference in its entirety.

### FIELD OF THE INVENTION

The present invention relates to cutting implements and, more particularly, ball bearing assisted cutting implements.

### BACKGROUND OF THE INVENTION

Under normal operating environments, a pair of scissors is required to have excellent rotatability and durability, which is crucial when operating under stressful cutting conditions. This is especially true for scissors employed in the gardening and floral related fields. Pivoting mechanisms having ball bearings have been used to enhance the rotatability of scissors. That is, according to the pair of scissors, an excellent rotational movement of the moving blade and the stationary blade can be maintained due to smooth rotational movement of the steel balls held by the bearing.

It is often the case that debris such as dirt, mud and organic matter enter the pivot between the bearing and steel balls through normal use. Depending upon moisture levels and materials, the pivot mechanisms often are susceptible to rust and molecular degradation. This leads to mechanical failure and a scissors not suitable for their intended purpose.

Considering the disadvantages faced by the prior art, it would be advantageous for a ball bearing assisted scissors to resist infiltration by unwanted debris. It would be further advantageous for such a scissor to be used in the floral or garden industries, thereby resisting dirt and other particulate matter from interfering with the ball bearing mechanism, for extended use while simultaneously maintaining excellent rotatability. It would be advantageous for such a scissors to be economically priced and capable of mass production. It would be a further advantage for a ball bearing mechanism, including a plurality of ball bearings, to have a wear resistant coating and maintain excellent rotation of a moving blade and a stationary blade of a pair of scissors with increased longevity.

### BRIEF SUMMARY OF THE INVENTION

Those utilizing the scissors for gardening and floral uses can overwork or injure the muscles and ligaments within the hand and wrist through repeated fatigue due to the pressure that is placed upon the handles when cutting materials of varying thickness and density. Ball bearing mechanisms have assisted cutting implements in achieving a smoother and easier rotational motion. However, the present invention provides a ball bearing assisted scissors that inhibits the debris and foreign material that is constantly present within the floral and gardening fields from entering the ball bearing mechanism. By providing a housing that encompasses the ball bearing mechanism, the unwanted debris is hindered from entering the mechanism.

More particularly, at least some embodiments, the present invention relates to high quality and durable scissors that utilize the advantageous reduced friction qualities of ball bearings while preventing the degradation of these qualities by inhibiting debris from entering the ball bearing mechanism.

Additionally, in at least some embodiments, the present invention relates to a ball bearing assisted scissors that has a replaceable ball bearing mechanism. The configuration of the present invention enables the user to easily detach the respective scissor blades and replace the ball bearing mechanism without much difficulty.

Further, in at least some embodiments, the present invention relates to the combination of a pair of scissors, a ball bearing mechanism, and a ball bearing mechanism housing. The housing provides the benefit of inhibiting the addition of unwanted debris into the ball bearing mechanism. The protrusion and raceway configuration further provides a more durable mechanism for longevity of use and increased lubricity.

### BRIEF DESCRIPTION OF THE DRAWINGS

FIG. 1 is a perspective view of a present pair of scissors in accordance with at least one embodiment of the invention.

FIG. 2 is an exploded view of a pair of scissors in accordance with at least one embodiment of the present invention;

FIG. 3 is an alternative exploded view of the scissors of FIG. 2.

FIG. 4 is a perspective view of the crevasse blade assembly in accordance with at least one embodiment of the present invention;

FIG. 5 is a perspective view of the protrusion blade assembly in accordance with at least one embodiment of the present invention;

FIG. 6 is a perspective view of the crevasse blade assembly of FIG. 4 with the addition of a ball bearing mechanism, in accordance with at least one embodiment of the present invention;

FIG. 7 is a perspective view of the protrusion blade assembly of FIG. 5 with the addition of a ball bearing mechanism, in accordance with at least one embodiment of the present invention;

FIG. 8 is a cross sectional view of the assembled pair of scissors of FIG. 1 taken along line 8-8; and

FIG. 9 is a cross sectional view of the assembled pair of scissors of FIG. 1 taken along line 9-9.

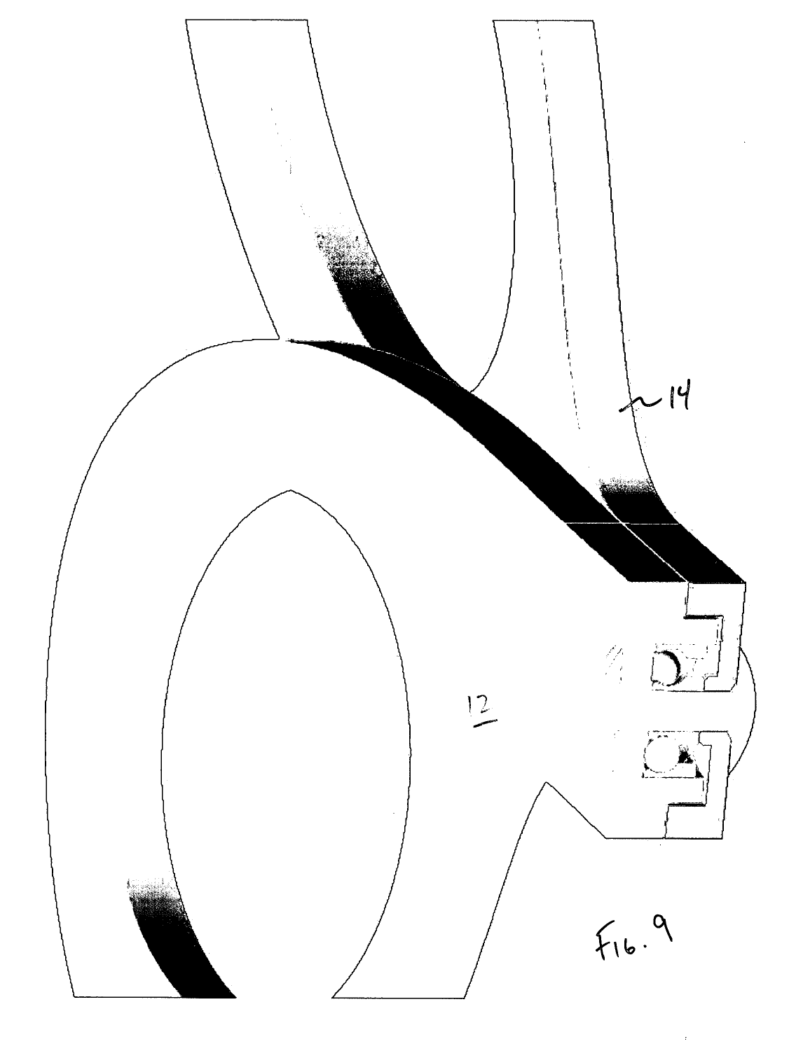

### DETAILED DESCRIPTION

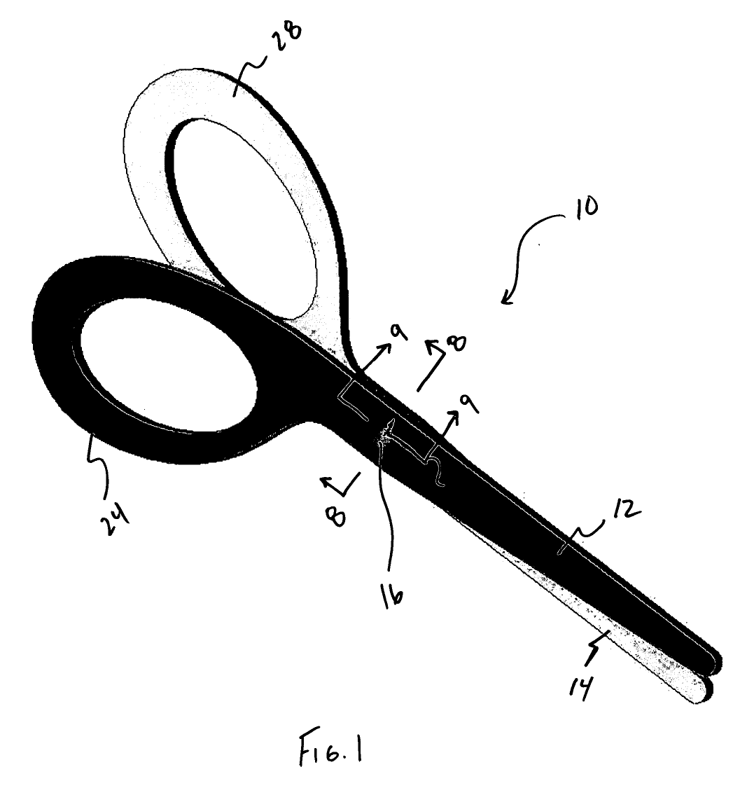

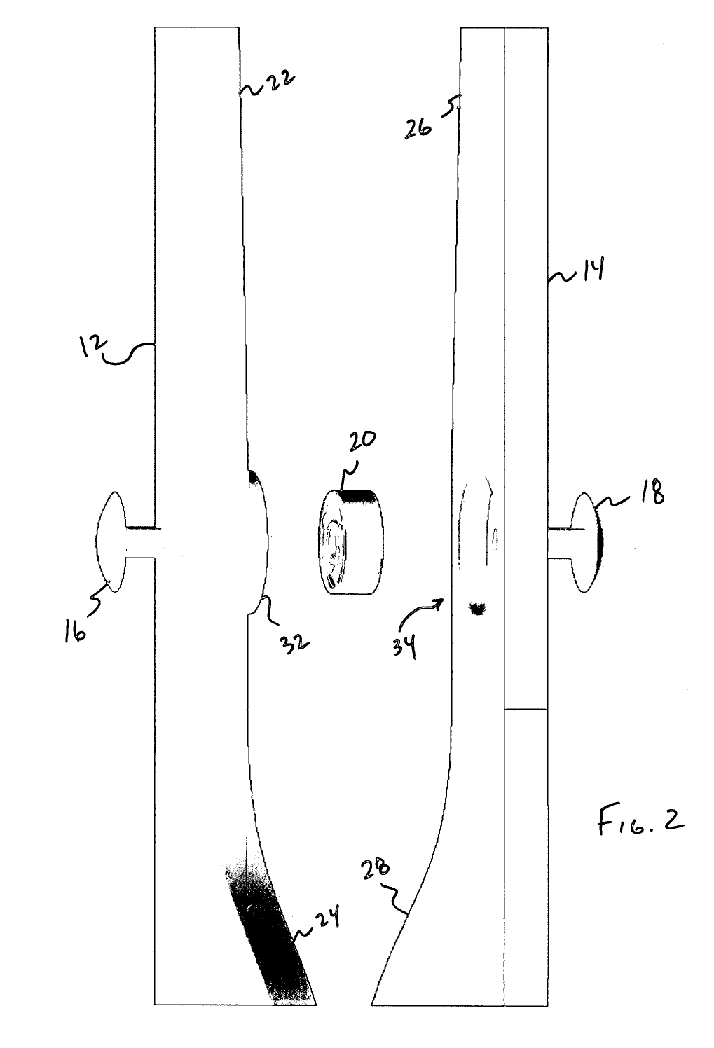

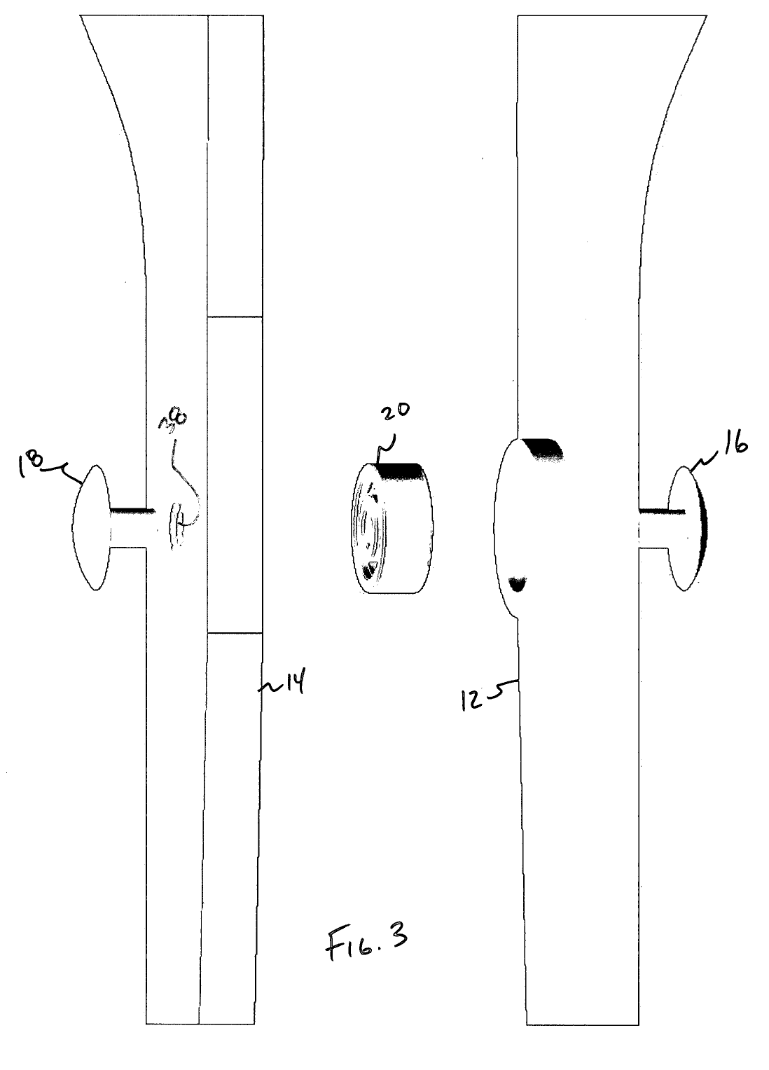

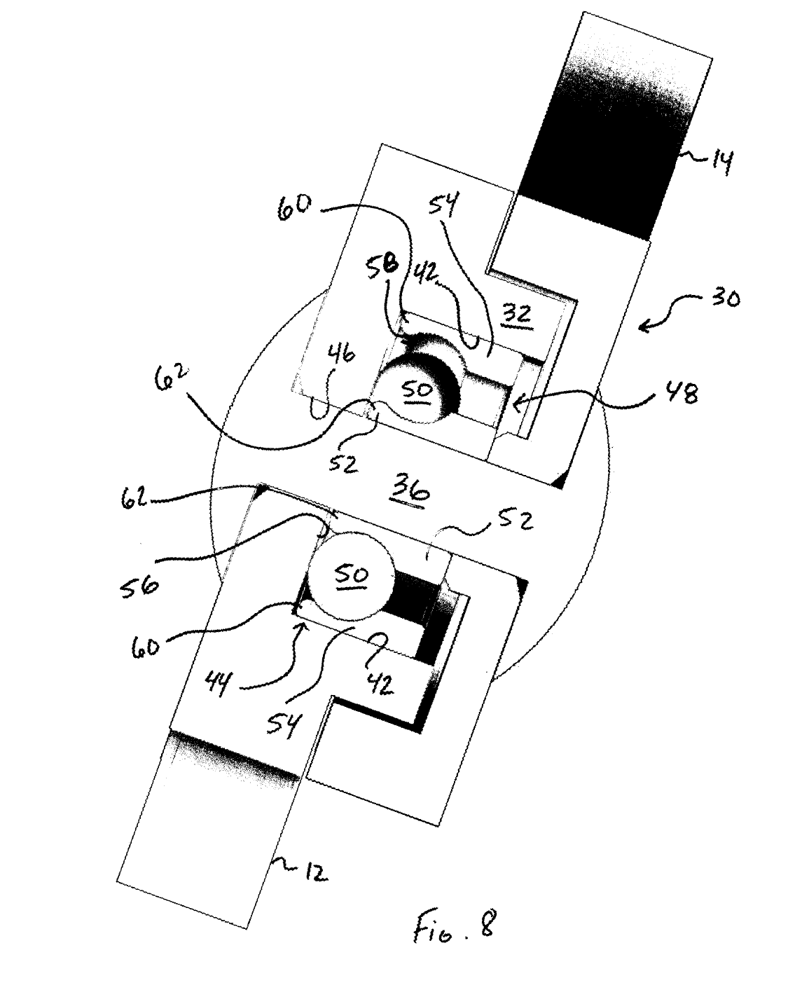

Referring to FIGS. 1-3, briefly in one aspect of the present invention a scissors 10 is shown having a male blade assembly 12, a crevasse blade assembly 14, a pair of pins 16, 18, and a ball bearing mechanism 20. The male blade assembly 12 includes a male blade 22 and a handle 24. The crevasse blade assembly 14 includes a crevasse blade 26 and a handle 28. When the assemblies 12,14 are combined a ball bearing housing 30 (FIG. 8) substantially and circumferentially surrounds the ball bearing mechanism 20. The housing 30 has a substantially circular protrusion 32 positioned proximal to a pivot point 36 on the assembly 12, and a substantially circular crevasse 34 positioned proximal to the pivot 36 on the assembly 14. Combination of pins 16,18 form pivot 36. The ball bearing mechanism 20 is seated between protrusion 32 and crevasse 34 such that the ball bearing mechanism 20 is substantially encompassed by the protrusion 32 and crevasse 34. Unwanted debris, such as chips, dusts, dirt, particulate matter and the like are inhibited from interfering with the mechanism 20 in part due to the housing 30 configuration.

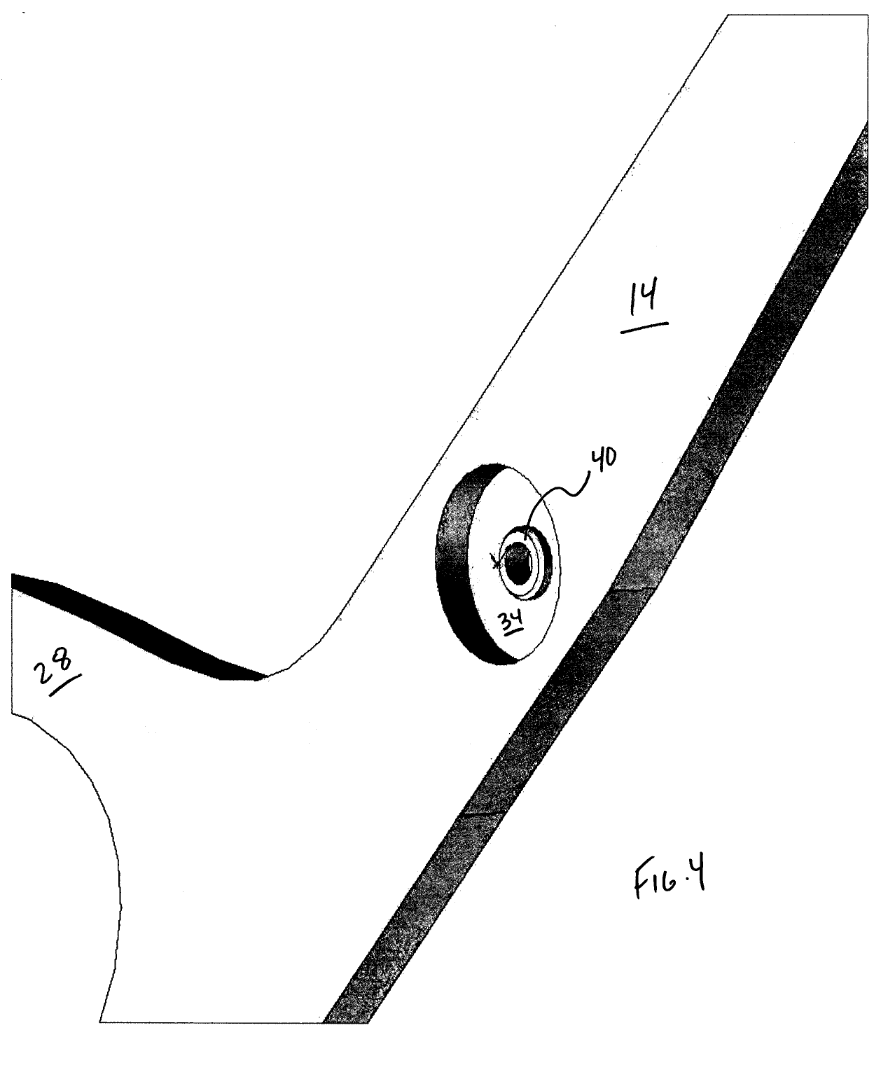

Referring to FIG. 4, the crevasse 34 is positioned on the interior portion of the assembly 14. The crevasse 34 is preferably circular in shape to provide for free rotational motion of the blade assemblies 12,14 around the pivot point 36 of the scissors 16 defined by the bolt hole 38. The assembly 14 alternatively can have a secondary protrusion 40, which extends circumferentially around the periphery of the bolt hole 38 and outward from the crevasse 34. The protrusion 40 can act as a spacer or a support for the ball bearing mechanism 20. Alternatively, the protrusion can be repositioned distal (not shown) to the bolt hole 38 and have the similar function as the protrusion 32. A corresponding secondary crevasse (not shown) can be positioned on the assembly 12, such that the housing 30 has a primary and secondary protrusion and crevasse pairing. This alternative embodiment (not shown) can further inhibit the infiltration of debris into the ball bearing mechanism housing 30. It is contemplated that oil or alternative lubricants, including synthetic lubricants, can be added within the housing 30 to further provide a sealed housing resistant to the infiltration of unwanted debris to the ball bearing mechanism 20.

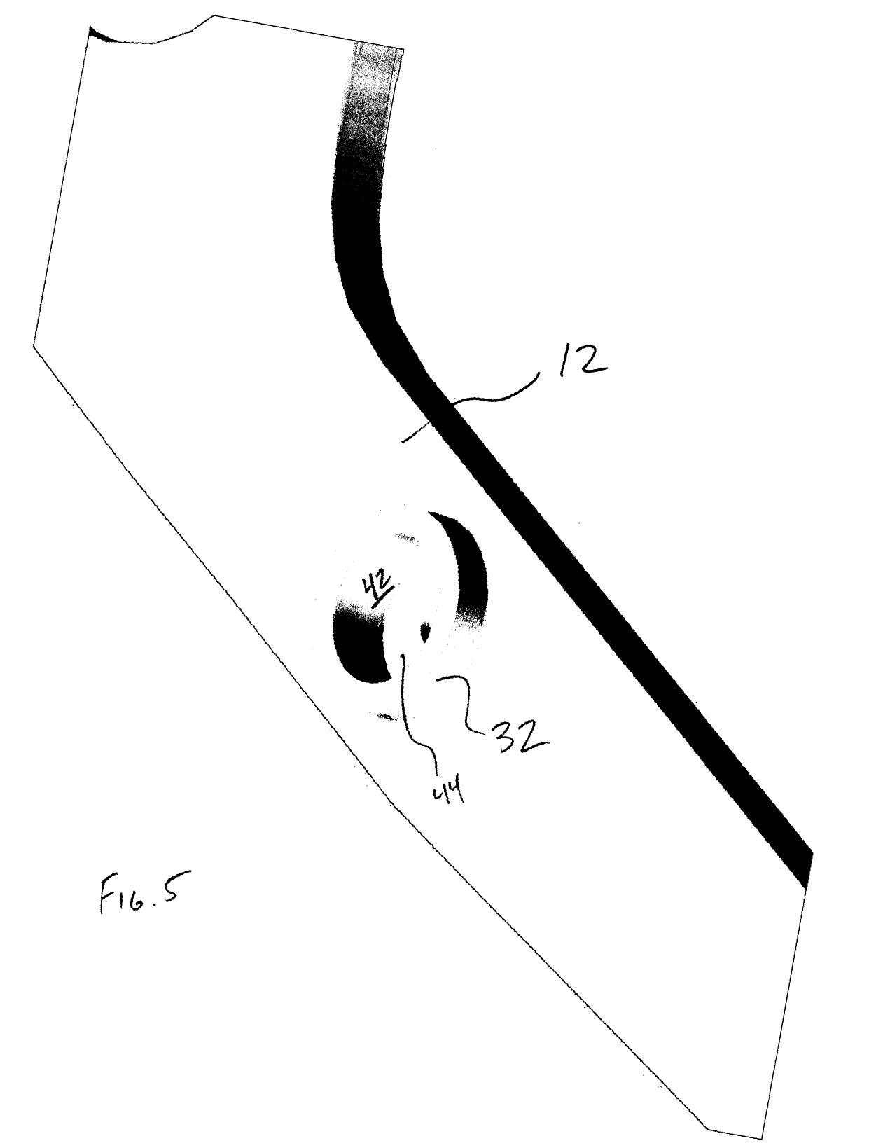

Referring to FIG. 5, the male blade assembly 12 is depicted has having a protrusion 32 extending outward from the interior surface 42 of the assembly 12. The protrusion 34 defines the periphery of a cutout 44. Centered within the cutout 44 is a bolt hole 46, which combined with bolt hole 38, defines the pivot point 36 of the scissors 10. The internal surface 48 of housing 30 is defined in part by protrusions 32,40, Crevasses 34, and cutout 44.

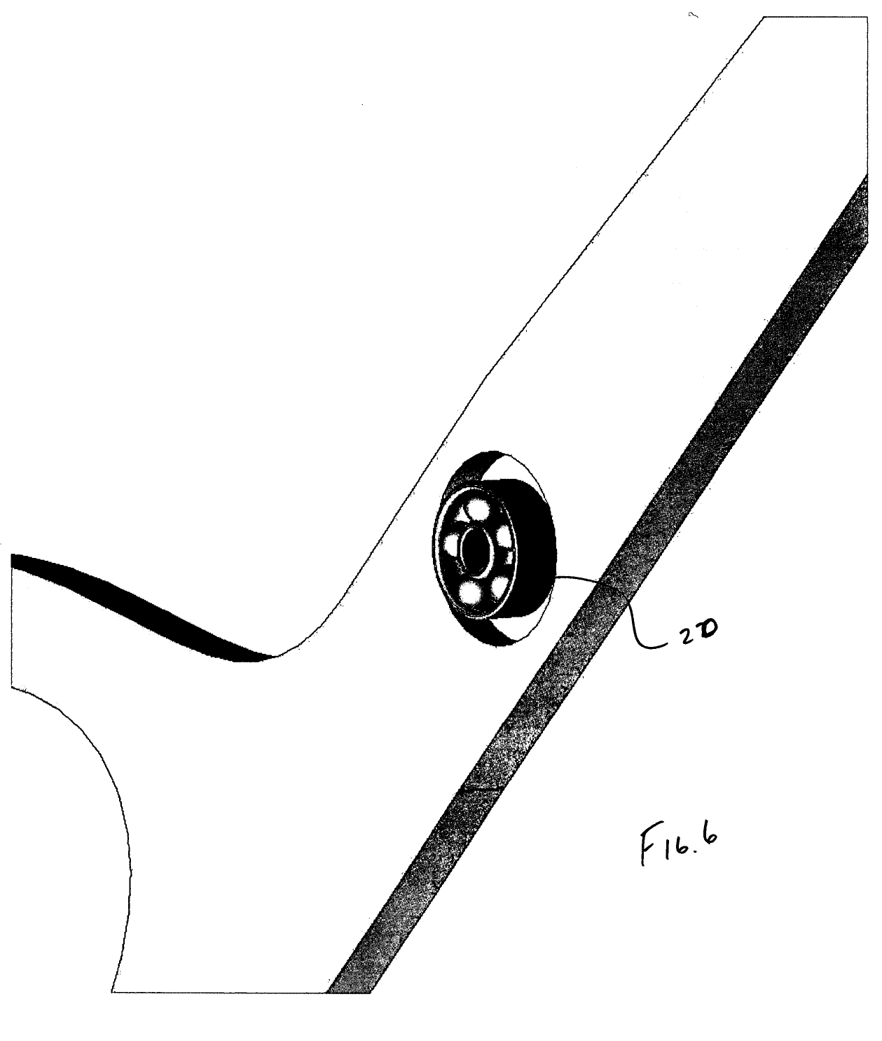

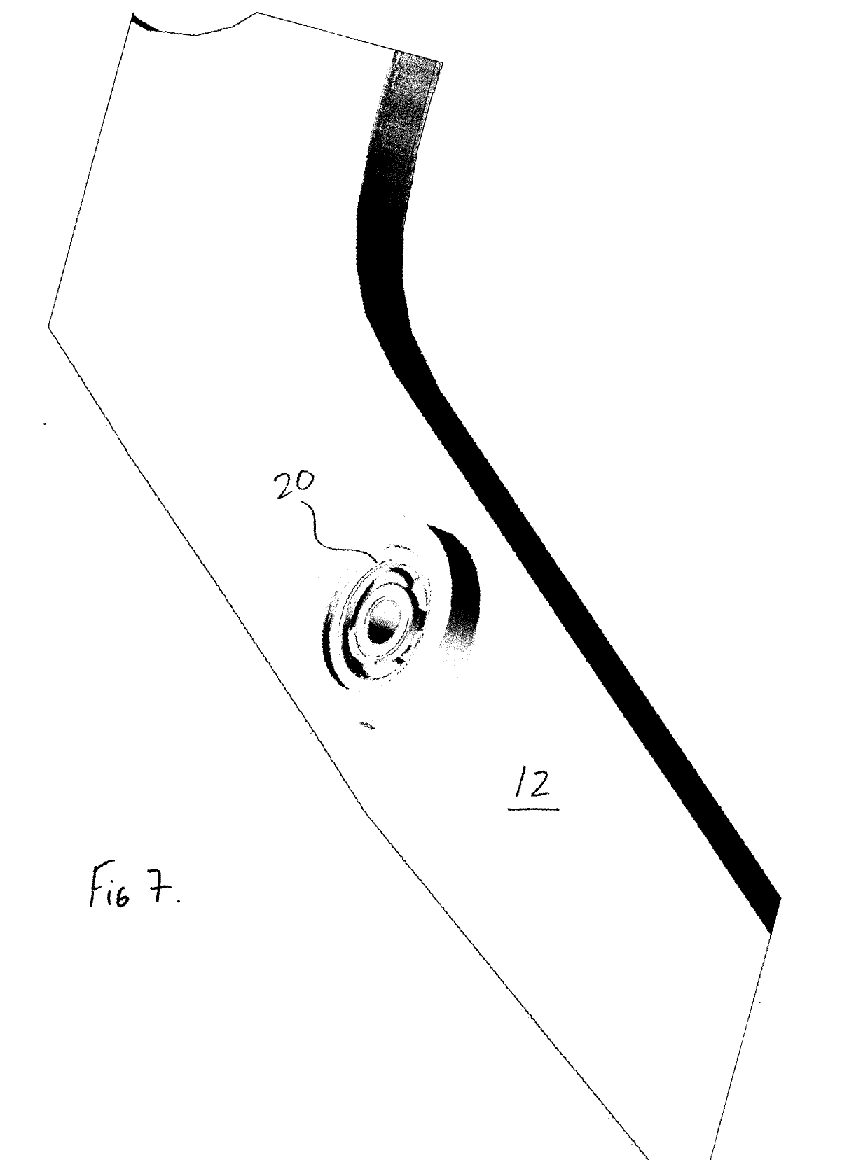

Referring to FIGS. 6-7, the ball bearing mechanism 20 is placed in conjunction with the crevasse blade assembly 14 (FIG. 4) and the male blade 12 (FIG. 5).

Referring to FIG. 8, a cross-sectional view of the housing 30 and pivot point 36 is shown. The ball bearing mechanism 20 is disc shaped and contains a plurality of ball bearings 50. The mechanism 20 includes a pivot section 52 and a ball bearing containment section 54. A ball bearing raceway 58 is defined by the combination of sections 52,54 and at least one ball bearing 50. Alternatively, the ball bearing mechanism can be enclosed at an end proximal to the crevasse 34 (not shown), thereby further limiting unwanted debris from interfering with the ball bearing mechanism 20. The bearings 38 are contained within the raceway 58 and are positionally defined by the orifices. The bearings 50 are in contact with inner surface 56 of the assembly 12. In an alternative embodiment, the ball bearings 50 contact inner surface of assembly 14. The ball bearings 50 can be made of a variety of materials including stainless steel. The ball bearings 50 as well as blades 22, 26 can be coated with a titanium chromium nitride coating, as taught by U.S. application Ser. No. 11/337,976, which is hereby incorporated in its entirety including all related patent documents and documents cited therein.

In an alternative embodiment (not shown), the ball bearings can be contained within separate ball bearing seats, instead of loosely contained within the raceway 58.

In an alternative embodiment, the bearing mechanism 20 can comprise a bearing defining plate having a plurality of orifices, wherein the orifices are as wide as twice the radius of the bearings. The bearing defining plate and bearings are sandwiched by a pair of flat bearing contacting plates, which may be integral to the respective blades of the scissors.

It is contemplated that the ball bearings 50 and/or ball bearing mechanism 20 have a wear resistant coating. The coating having compounds selected from the group including titanium nitride, chromium nitride, titanium chromium nitride, titanium carbo nitride, and chromium carbo nitride. It is further contemplated that a variety of lubricants known in the art can be used to maintain pivotal lubricity.

The ball bearings 50 are positioned within the raceway 56 such that a portion of the bearing 50 extends beyond the top surfaces 60, 62 (FIG. 8). Alternatively, the distance that bearings 50 extend beyond the top surfaces 60,62 can be changed dependant upon the use and configuration of scissors 10. Ball bearings 50 are preferably in a range of about 1 mm to about 2 cm in diameter. The ball bearing mechanism 20 can include one or more ball bearings. In at least one embodiment of the present invention the number of ball bearings 50 ranges from about 3 to about 7. Additionally, smaller or larger bearings 50 are contemplated by the present invention.

The scissors 10 include a disk-shaped mechanism 20 and a plurality of steel balls 50, the mechanism 20 having front and rear sides, and an aperture at the center thereof, through which a pivot post 42 of the scissors 10 pierces. In an alternative embodiment (not shown), a plurality of steel ball holding apertures are annularly arranged around the above aperture, for rotatably holding the above steel balls under a condition where the spherical surface of each steel ball, is projected beyond either side of the mechanism 20. The steel balls 50 are held in the steel ball holding apertures one by one. Unwanted debris, such as chips, dusts, dirt, particulate matter and the like are inhibited from interfering with the mechanism 20. Thus, the function of the bearing can be maintained for a long period. In addition, with such a simple structure, a working system such as an assembly or disassembly step for scissors would not become complicated, and the manufacturing cost can be held down, thereby making it possible to provide a pair of scissors easy to handle and economic.

In an alternative embodiment (not shown), the pins 16,18 form a removable pivot/post 42 arrangement. Pins 16,18 can fit together as a nut and bolt arrangement, which can be manually tensioned based upon a user's cutting needs. Additionally, the blades 12, 14 can be detached by unscrewing the pivot. In the event of significant use and wear, the bearing mechanism can be replaced. It is further contemplated that instrument 10 is in the form of a pliers, snips, or any other similarly constructed hand tool.

It is specifically intended that the present invention not be limited to the embodiments and illustrations contained herein, but include modified forms of those embodiments including portions of the embodiments and combinations of elements of different embodiments that come within the scope of the following claims.

What is claimed is:

1. A ball bearing assisted scissors comprising:
a first and second blade assemblies pivotally connected by a pivot, the pivot comprising a pivot post for maintaining pivotal communication between the first and second blade, a ball bearing mechanism for assisting pivotal rotation with respect to the assemblies, and a mechanism housing, wherein the housing comprises a substantially circular protrusion extending from the first blade and a substantially circular crevasse situated on the second blade, wherein the housing substantially circumferentially encompasses the ball bearing mechanism; and
a first handle integral with the first blade and a second handle integral with the second blade.

2. The scissors of claim 1, wherein the ball bearings comprise a coating, the coating including chromium nitride and titanium nitride.

3. The scissors of claim 1, further comprising a coating, the coating including chromium nitride and titanium nitride.

4. The scissors of claim 1, further comprising a substantially circular mechanism support circumferentially extending from the second blade assembly proximal to the pivot post, the support in communication with the ball bearing mechanism and configured to support the mechanism.

5. The scissors of claim 1, wherein the pivot post is readily removable and configured for blade assembly tension adjustment.

6. A hand held instrument comprising a pair of limb assemblies pivotally connected at a joint, the joint comprising a pivot post for maintaining pivotal communication between the first and second limb assemblies, a ball bearing mechanism for assisting pivotal rotation with respect to the blades and a mechanism housing, the mechanism substantially circumferentially enclosed by the housing, the ball mechanism comparing a plurality of ball bearings in direct communication with the first limb assembly.

7. A cutting instrument comprising:
a first instrument assembly pivotally connected to a second instrument assembly, at least one of the assemblies comprising a cutting blade and a handle; and
a pivot assembly comprising a connector post for joining the instrument assemblies, a ball bearing mechanism for mechanically assisting pivotal movement of the assemblies, and a ball bearing mechanism housing circumferentially surrounding the ball bearing mechanism, the housing configured to inhibit debris from interfering with the ball bearing mechanism.
